(19) United States
(12) Patent Application Publication
(10) Pub. No.: US 2024/0103492 A1
(43) Pub. Date: Mar. 28, 2024

(54) AUTOMATION POWERED ENDPOINT LEGACY DUPLICITY

(71) Applicant: INTERNATIONAL BUSINESS MACHINES CORPORATION, Arrnonk, NY (US)

(72) Inventors: Melanie Dauber, Oceanside, NY (US); Zachary A. Silverstein, Georgetown, TX (US); Jacob Ryan Jepperson, St Paul, MN (US); Spencer Thomas Reynolds, Austin, TX (US); Jeremy R. Fox, Georgetown, TX (US)

(21) Appl. No.: 17/953,688

(22) Filed: Sep. 27, 2022

(51) Int. Cl. G05B 19/4155; G06F 8/61; G06F 8/65; G06F 9/54

(52) U.S. Cl. CPC G05B 19/4155; G06F 8/61; G06F 8/65; G06F 9/543; G05B 2219/50391

(57) ABSTRACT

A method for data transfer from a legacy system to a modernized application alternative to the legacy system is provided. A Robotic Process Automation (RPA) agent monitors incoming legacy payloads. The RPA agent creates an integration pathway from the legacy system to the modernized application alternative to the legacy system. The RPA agent intercepts the incoming legacy payloads using any of payload injection, cancellation, or workflow interruption by integrating the RPA agent at a User Interface (UI) or an Application Programming Interface (API) level. The RPA agent captures the incoming legacy payloads. The RPA agent executes a determination of heritage, modernized, or mixed origination. The method also includes installing, through the integration pathway under a control of the RPA agent, portions of the legacy system corresponding to the incoming legacy payloads into the modernized application alternative to the legacy system responsive to the determination of heritage, modernized, or mixed origination.

### BACKGROUND

The present invention generally relates to updating computer systems, and more particularly to automation powered endpoint legacy duplicity.

Often times, customers need assistance moving from heritage (legacy) systems to newer systems. Modernization is a massive place for opportunity. However, many customers are hesitant about actually making the migration due to the dependency of so many applications on the legacy system for stability, such as financial users, risks, time and cost. One massive place for this is Mainframe systems. A solution is needed that can help automate that move easier with as minimal of an impact as possible.

### SUMMARY

According to aspects of the present invention, a computer-implemented method for data transfer from a legacy system to a modernized application alternative to the legacy system is provided. The method includes initializing a Robotic Process Automation (RPA) agent on a middleware server. The method further includes monitoring, by the RPA agent, incoming legacy payloads. The method also includes creating, by the RPA agent, an integration pathway from the legacy system to the modernized application alternative to the legacy system. The method additionally includes intercepting, by the RPA agent, the incoming legacy payloads using a method selected from the group consisting of payload injection, cancellation, and workflow interruption by integrating the RPA agent at a level selected from the group consisting of a User Interface (UI) and an Application Programming Interface (API) level. The method further includes capturing, by the RPA agent, the incoming legacy payloads. The method also includes executing, by the RPA agent, a determination of heritage, modernized, or mixed origination. The method also includes installing, through the integration pathway under a control of the RPA agent, one or more portions of the legacy system corresponding to the incoming legacy payloads into the modernized application alternative to the legacy system responsive to the determination of heritage, modernized, or mixed origination.

According to other aspects of the present invention, a computer program product for data transfer from a legacy system to a modernized application alternative to the legacy system is provided. The computer program product includes a non-transitory computer readable storage medium having program instructions embodied therewith. The program instructions are executable by a computer to cause the computer to perform a method. The method includes initializing a Robotic Process Automation (RPA) agent on the computer. The computer is a middleware server. The method further includes monitoring, by the RPA agent, incoming legacy payloads. The method also includes creating, by the RPA agent, an integration pathway from the legacy system to the modernized application alternative to the legacy system. The method additionally includes intercepting, by the RPA agent, the incoming legacy payloads using a method selected from the group consisting of payload injection, cancellation, and workflow interruption by integrating the RPA agent at a level selected from the group consisting of a User Interface (UI) and an Application Programming Interface (API) level. The method also includes capturing, by the RPA agent, the incoming legacy payloads. The method additionally includes executing, by the RPA agent, a determination of heritage, modernized, or mixed origination. The method further includes installing, through the integration pathway under a control of the RPA agent, one or more portions of the legacy system corresponding to the incoming legacy payloads into the modernized application alternative to the legacy system responsive to the determination of heritage, modernized, or mixed origination.

According to still other aspects of the present invention, a system for data transfer from a legacy system to a modernized application alternative to the legacy system is provided. The system includes a middleware server having a Robotic Process Automation (RPA) agent. The RPA agent is configured to monitor incoming legacy payloads. The RPA agent is further configured to create an integration pathway from the legacy system to the modernized application alternative to the legacy system. The RPA agent is also configured to intercept the incoming legacy payloads using a method selected from the group consisting of payload injection, cancellation, and workflow interruption by integrating the RPA agent at a level selected from the group consisting of a User Interface (UI) and an Application Programming Interface (API) level. The RPA agent is additionally configured to capture the incoming legacy payloads. The RPA agent is further configured to execute a determination of heritage, modernized, or mixed origination. The RPA agent is also configured to install, through the integration pathway under a control of the RPA agent, one or more portions of the legacy system corresponding to the incoming legacy payloads into the modernized application alternative to the legacy system responsive to the determination of heritage, modernized, or mixed origination.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a computing environment, in accordance with an embodiment of the present invention;

FIG. 2 is a block diagram showing an exemplary system flow for automation powered endpoint legacy duplicity for a first use case, in accordance with an embodiment of the present invention;

FIG. 3 is a block diagram showing flow for an exemplary system for automation powered endpoint legacy duplicity for a second use case, in accordance with an embodiment of the present invention; and

FIGS. 4-5 are block diagrams showing an exemplary method for data transfer from a legacy system to a modernized application alternative to the legacy system, in accordance with an embodiment of the present invention.

### DETAILED DESCRIPTION

Embodiments of the present invention are directed to automation powered endpoint legacy duplicity.

Embodiments of the present invention provide an infrastructure and system to better allow for heritage and legacy system migrations over conventional approaches.

Embodiments of the present invention provide a system and method that utilize robotic process automation and endpoint duplicity architecture to support heritage/legacy migrations via drop in components.

In an embodiment, an Application Programming Interface (API) access point to a mainframe system will plug in a Robotic Process Automation (RPA) component that will sit on the “inbound” path of requests coming into the query and route requests to legacy or non-legacy systems.

In an embodiment, the invention will capture the inbound requests and utilize a reconciling action powered by process automation where the endpoint will query a target modernized System of Record (SOR) for entries that match the inbound request.

In an embodiment, based on the administrative decision, the architecture may opt to duplicate incoming requests to both the heritage and modernized SOR or selectively choose a single SOR to store the requests.

In an embodiment, upon modernization failure or issues, the API endpoint remains static and balances to the heritage application.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

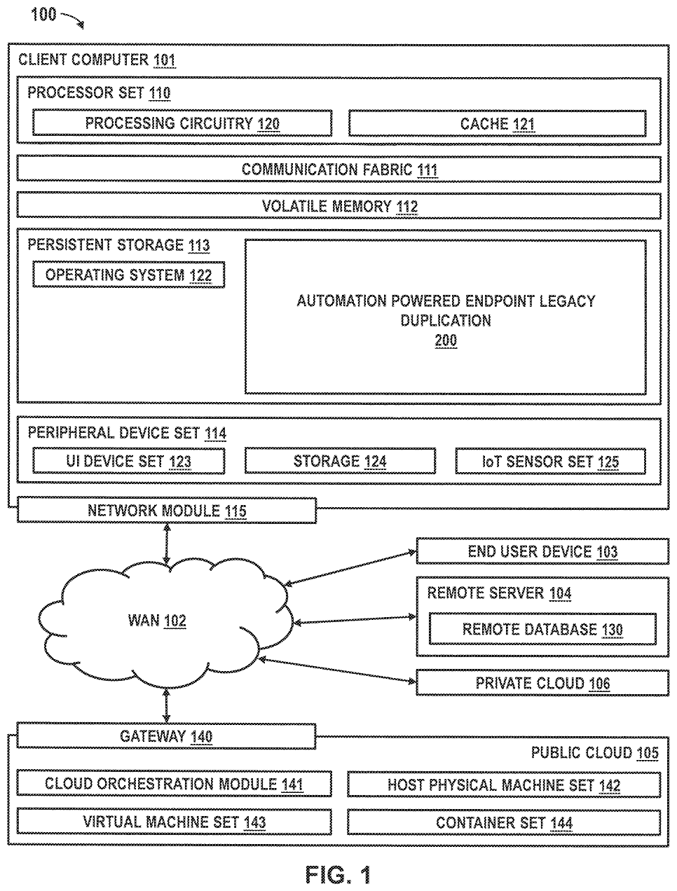

FIG. 1 is a block diagram of a computing environment 100, in accordance with an embodiment of the present invention.

Computing environment 100 contains an example of an environment for the execution of at least some of the computer code involved in performing the inventive methods, such as automation powered endpoint legacy duplicity 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A description will now be given regarding a first use case, in accordance with an embodiment of the present invention.

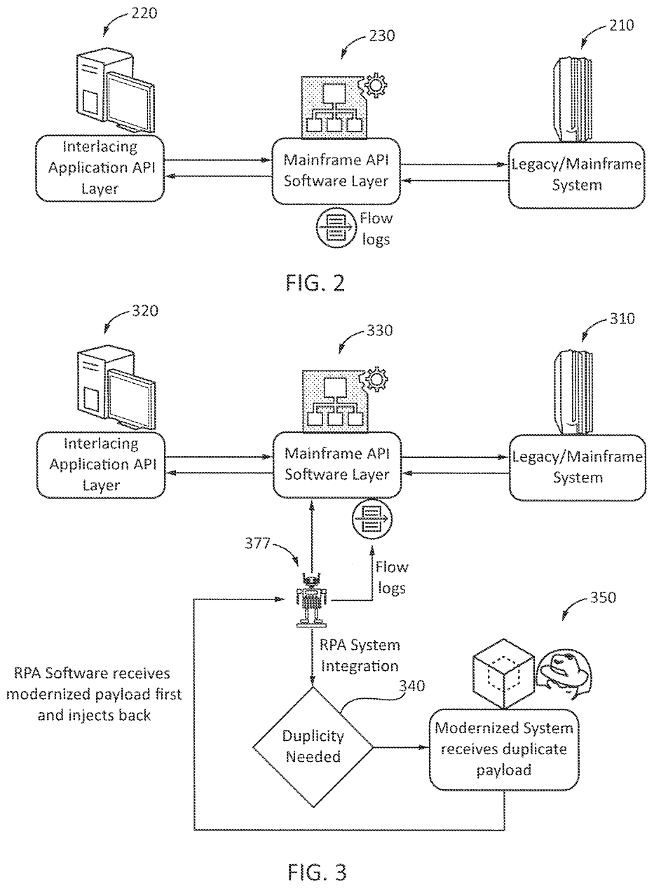

FIG. 2 is a block diagram showing an exemplary system flow for automation powered endpoint legacy duplicity for a first use case, in accordance with an embodiment of the present invention.

The system includes a legacy system 210, a modernized application alternative 220 to the legacy system 210, and a mainframe API software layer 230.

Customer XYZ is interested in modernizing applications running on their legacy/mainframe system 210. However, they have concerns of impacting their existing systems of record, data integrity and are unsure of the benefit that they will see from spending time and effort on a complex migration.

Customer XYZ opts in to use the present invention which will help them determine which parts of their legacy/mainframe system 210 are recommended to modernize and which aspects to protect.

As requests in legacy payloads come into the mainframe API software layer 230, a Robotic Process Automation (RPA) agent therein intercepts the inbound requests to evaluate whether a duplicate endpoint is needed. An embodiment of the invention utilizes a reconciling action powered by process automation where the endpoint will query a modernized System of Record (SOR) for entries that match an inbound request.

The RPA agent detects a service that can be modernized without impacting the existing system of record. The RPA agent then triggers that duplicity is needed and sends both the modernized system 220 and the heritage system 210 a duplicate payload. This actions protects the system 210 in case of modernization failures.

Data integrity is maintained and redundancy used to ensure stability of the existing heritage system while onboarding a modernized architecture.

Another scenario, could be that the end user decides to send the duplicated payload only to a specific heritage system that they intend to use for disaster recovery.

In case of issues throughout the modernization process, the end user also has the ability to have the API endpoint remains static and balances to the heritage application.

This results in Customer XYZ automating their migration process, mitigating risks when migrating endpoints off of mainframe and legacy systems, and creates a stronger backup system for unexpected failures.

A description will now be given regarding a second use case, in accordance with an embodiment of the present invention.

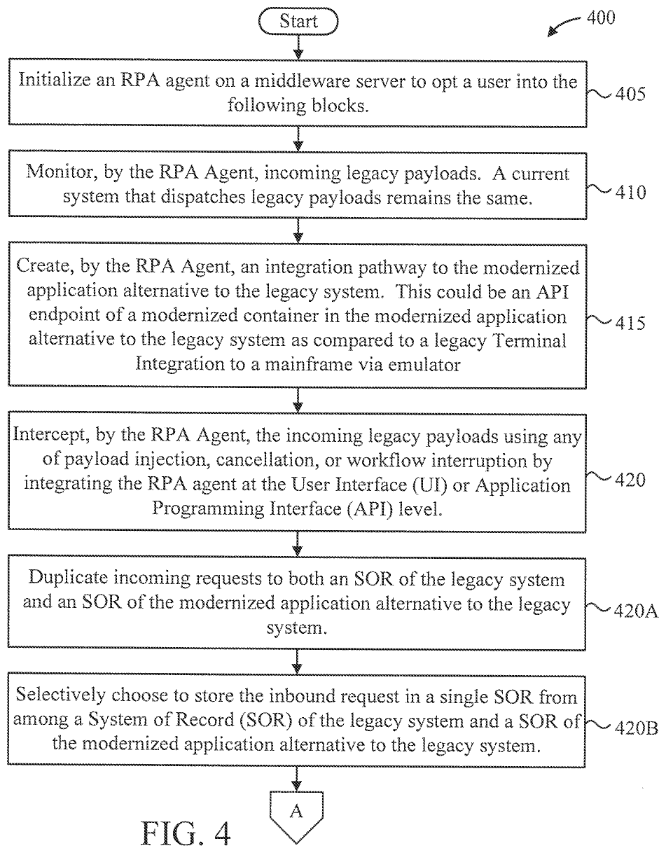

FIG. 3 is a block diagram showing a flow for an exemplary system 300 for automation powered endpoint legacy duplicity for a second use case, in accordance with an embodiment of the present invention.

The system 300 includes a legacy (or mainframe) system 310, a modernized application alternative 320 to the legacy system 310, and a mainframe API software layer 330.

An intelligent workflow for payment processing has been built on the legacy system 310. Some automated scripting and manual processing is involved in the end-to-end process. Bank ABC needs to modernize this application to improve processing time, scalability, monitoring and resource consumption

An embodiment of the present invention tracks this mainframe process and the data. Modernization opportunities are detected to migrate data from the mainframe to a modern SOR. Additionally, endpoint duplicity 340 is used to automatically replicate data between the legacy system 310 and mainframe API software layer 330 as processing occurs such that the modernized application alternative 330 receives the duplicate payload 350. An RPA agent 377 in the mainframe API software layer 330 also detects the legacy system's 310 automated scripts and manual tasks within the application.

The RPA agent automatically recreates the mainframe scripts using the target modern architecture to assist in the migration process (i.e., RPA bot generation, JAVA script command, and so forth).

Manual tasks within the legacy system 310 are recorded, and again automatically recreated in the modernized application alternative 320 with process flow diagrams, business object model (data) and user interfaces.

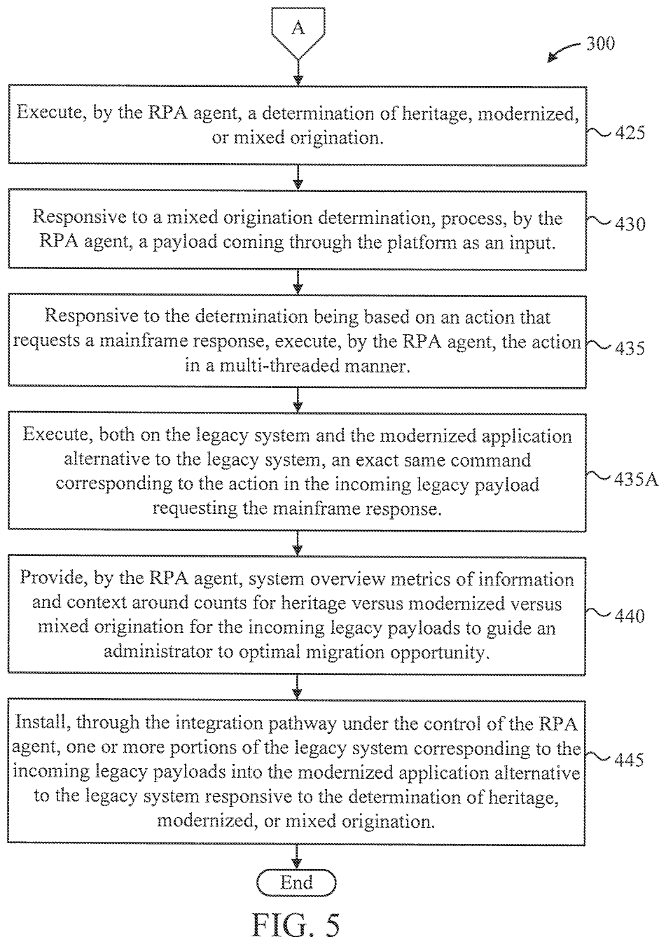

FIGS. 4-5 are block diagrams showing an exemplary method for data transfer from a legacy system to a modernized application alternative to the legacy system, in accordance with an embodiment of the present invention.

At block 405, initialize an RPA agent on a middleware server to opt a user into the following blocks.

At block 410, monitor, by the RPA Agent, incoming legacy payloads. A current system that dispatches legacy payloads remains the same.

At block 415, create, by the RPA Agent, an integration pathway to the modernized application alternative to the legacy system. This could be an API endpoint of a modernized container in the modernized application alternative to the legacy system as compared to a legacy Terminal Integration to a mainframe via emulator.

At block 420, intercept, by the RPA Agent, the incoming legacy payloads using any of payload injection, cancellation, or workflow interruption by integrating the RPA agent at the User Interface (UT) or Application Programming Interface (API) level. In some manners this block is non-disruptive, where it will not inject the incoming legacy payload, but rather it will read the current ongoing payload. Interception is intended to include capture of the payloads.

In an embodiment, block 420 can include one or more of block 420A through 420B.

At block 420A, duplicate incoming requests to both an SOR of the legacy system and an SOR of the modernized application alternative to the legacy system.

At block 420B, selectively choose to store the inbound request in a single SOR from among a System of Record (SOR) of the legacy system and a SOR of the modernized application alternative to the legacy system.

At block 425, execute, by the RPA agent, a determination of heritage, modernized, or mixed origination. Heritage origination may be an update/delete type activity against the mainframe where a preceding record is needed that has not been written to the modernized platform. Modernized origination may be a create where no record has existed yet in the mainframe system. The end resultant of these modernized payloads will be a mixed origination. This means that the end result of these modernized payloads will be a document that contains information from both the modernized system and the heritage system. This document can be used to help understand the requirements of the modernized system and the heritage/legacy based system. A mixed origination may be a Requirement Understanding Document (RUD) if the record already exists in both the modernized system and the heritage system.

At block 430, responsive to a mixed origination determination, process, by the RPA agent, a payload coming through the platform as an input.

At block 435, responsive to the determination being based on an action that requests a mainframe response, execute, by the RPA agent, the action in a multi-threaded manner.

In an embodiment, block 435 can include block 435A.

At block 435A, execute, both on the legacy system and the modernized application alternative to the legacy system, an exact same command corresponding to the action in the incoming legacy payload requesting the mainframe response.

The RPA agent will inject itself as a response to the input if the modernized platform returns the data faster or more efficiently or more completely.

At block 440, provide, by the RPA agent, system overview metrics of information and context around counts for heritage versus modernized versus mixed origination for the incoming legacy payloads to guide an administrator to optimal migration opportunity.

At block 445, install, through the integration pathway under the control of the RPA agent, one or more portions of the legacy system corresponding to the incoming legacy payloads into the modernized application alternative to the legacy system responsive to the determination of heritage, modernized, or mixed origination. The installation can be subject to any administrator input on the migration.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for data transfer from a legacy system to a modernized application alternative to the legacy system, the method comprising:
initializing a Robotic Process Automation (RPA) agent on a middleware server;
monitoring, by the RPA agent, incoming legacy payloads;
creating, by the RPA agent, an integration pathway from the legacy system to the modernized application alternative to the legacy system;
intercepting, by the RPA agent, the incoming legacy payloads using a method selected from the group consisting of payload injection, cancellation, and workflow interruption by integrating the RPA agent at a level selected from the group consisting of a User Interface (UI) and an Application Programming Interface (API) level;
capturing, by the RPA agent, the incoming legacy payloads;
executing, by the RPA agent, a determination of heritage, modernized, or mixed origination; and
installing, through the integration pathway under a control of the RPA agent, one or more portions of the legacy system corresponding to the incoming legacy payloads into the modernized application alternative to the legacy system responsive to the determination of heritage, modernized, or mixed origination.

2. The computer-implemented method of claim 1, wherein the integration pathway from the legacy system to the modernized application alternative to the legacy system comprises an API endpoint of a modernized container in the modernized application alternative to the legacy system.

3. The computer-implemented method of claim 2, wherein upon a modernization failure, the API endpoint of the modernized container remains static and balances to the legacy system.

4. The computer-implemented method of claim 1, wherein intercepting the incoming legacy payloads is performed to be non-disruptive by avoiding injecting the incoming legacy payloads, instead reading current ongoing payloads.

5. The computer-implemented method of claim 1, wherein the heritage origination comprises an update/delete type activity against a mainframe system where a preceding record is needed that has not been written to the modernized application alternative to the legacy system.

6. The computer-implemented method of claim 1, wherein the modernized origination comprises creating a record where no record has existed yet in the legacy system.

7. The computer-implemented method of claim 1, wherein the mixed origination comprises a Requirement Understanding Document (RUD) if a record already exists in both the legacy system and the modernized application alternative to the legacy system.

8. The computer-implemented method of claim 1, wherein the mixed origination comprises a configuration of the RPA agent processing an incoming legacy payload coming through the legacy system as an input and executing, in a multi-threaded manner, an action in the incoming legacy payload requesting a mainframe response.

9. The computer-implemented method of claim 8, wherein executing, in the multi-threaded manner comprises the RPA agent taking parallel actions to execute, both on the legacy system and the modernized application alternative to the legacy system, an exact same command corresponding to the action in the incoming legacy payload requesting the mainframe response.

10. The computer-implemented method of claim 9, wherein the RPA agent will inject itself as a response to the input if the modernized application alternative to the legacy system returns the data faster or more efficiently or more completely than the legacy system.

11. The computer-implemented method of claim 1, further comprising providing system overview metrics of information and context around counts for heritage versus modernized versus mixed origination for the incoming legacy payloads to guide an administrator to optimal migration opportunity.

12. The computer-implemented method of claim 1, wherein an inbound request in the incoming legacy payloads is intercepted and evaluated by the RPA agent to determine whether a duplicate endpoint is needed based on the endpoint querying a modernized System of Record (SOR) for entries that match the inbound request.

13. The computer-implemented method of claim 12, further comprising duplicating incoming requests to both an SOR of the legacy system and an SOR of the modernized application alternative to the legacy system.

14. The computer-implemented method of claim 12, further comprising selectively choosing to store the inbound request in a single SOR from among an SOR of the legacy system and an SOR of the modernized application alternative to the legacy system.

15. A computer program product for data transfer from a legacy system to a modernized application alternative to the legacy system, the computer program product comprising a non-transitory computer readable storage medium having program instructions embodied therewith, the program instructions executable by a computer to cause the computer to perform a method comprising:
initializing a Robotic Process Automation (RPA) agent on the computer, wherein the computer is a middleware server;
monitoring, by the RPA agent, incoming legacy payloads;
creating, by the RPA agent, an integration pathway from the legacy system to the modernized application alternative to the legacy system;
intercepting, by the RPA agent, the incoming legacy payloads using a method selected from the group consisting of payload injection, cancellation, and workflow interruption by integrating the RPA agent at a level selected from the group consisting of a User Interface (UI) and an Application Programming Interface (API) level; capturing, by the RPA agent, the incoming legacy payloads;
executing, by the RPA agent, a determination of heritage, modernized, or mixed origination; and
installing, through the integration pathway under a control of the RPA agent, one or more portions of the legacy system corresponding to the incoming legacy payloads into the modernized application alternative to the legacy system responsive to the determination of heritage, modernized, or mixed origination.

16. The computer program product of claim 15, wherein the integration pathway from the legacy system to the modernized application alternative to the legacy system comprises an API endpoint of a modernized container in the modernized application alternative to the legacy system.

17. The computer program product of claim 15, wherein upon a modernization failure, the API endpoint of the modernized container remains static and balances to the legacy system.

18. The computer program product of claim 15, wherein intercepting the incoming legacy payloads is performed to be non-disruptive by avoiding injecting the incoming legacy payloads, instead reading current ongoing payloads.

19. The computer program product of claim 15, wherein the heritage origination comprises an update/delete type activity against a mainframe system where a preceding record is needed that has not been written to the modernized application alternative to the legacy system.

20. A system for data transfer from a legacy system to a modernized application alternative to the legacy system, the system comprising:
a middleware server having a Robotic Process Automation (RPA) agent, wherein the RPA agent is configured to:
monitor incoming legacy payloads;
create an integration pathway from the legacy system to the modernized application alternative to the legacy system;
intercept the incoming legacy payloads using a method selected from the group consisting of payload injection, cancellation, and workflow interruption by integrating the RPA agent at a level selected from the group consisting of a User Interface (UI) and an Application Programming Interface (API) level; capture the incoming legacy payloads;
execute a determination of heritage, modernized, or mixed origination; and
install, through the integration pathway under a control of the RPA agent, one or more portions of the legacy system corresponding to the incoming legacy payloads into the modernized application alternative to the legacy system responsive to the determination of heritage, modernized, or mixed origination.
